(19) United States
(12) Patent Application Publication
(10) Pub. No.: US 2026/0355827 A1
(43) Pub. Date: Nov. 12, 2026

(54) CEMENTED CARBIDE CUTTING TOOL

(71) Applicant: AB SANDVIK COROMANT, Sandviken (SE)

(72) Inventors: Jose GARCIA, Sandviken (SE); Andrei CHYCHKO, Sandviken (SE)

(21) Appl. No.: 19/139,767

(22) PCT Filed: Dec. 5, 2023
(86) PCT No.: PCT/EP2023/084231

§ 371 Date: Jun. 16, 2025

(30) Foreign Application Priority Data
Dec. 20, 2022 (EP) 22214877.7

(51) Int. Cl. B23B 27/14; B22F 3/15; B22F 5/00; C22C 1/055; C22C 29/06; C22C 29/08

(52) U.S. Cl. CPC B23B 27/148; B22F 3/15; C22C 1/055; C22C 29/067; C22C 29/08; B22F 2005/001; B23B 2222/28

(57) ABSTRACT

A cutting tool includes a cemented carbide substrate, where the cemented carbide has a hard phase including WC, a mixed carbide phase and a metal binder. The cemented carbide includes the elements V, Cr, Ni and Fe in such amounts so that:
the weight fraction V/(V+Cr+Ni+Fe) is between 0.0030 and 0.050,
the weight fraction Cr/(V+Cr+Ni+Fe) is between 0.010 and 0.040,
the weight fraction Ni/(V+Cr+Ni+Fe) is between 0.030 and less than 0.050, and
the weight fraction Fe/(V+Cr+Ni+Fe) is between 0.86 and 0.967.

The cemented carbide according to the present invention shows toughness and hardness properties comparable with cemented carbides with Co-binder.

The present invention relates to a cutting tool comprising a cemented carbide substrate with a Fe-based binder, where the cemented carbide further comprising V, Cr and Ni. The invention also relates to a method of making such cutting tool.

### BACKGROUND

Cemented carbides based on WC with a cobalt binder have been known in the art for almost one hundred years. Other metals that are known as binder metals in cemented carbides are iron and nickel, however cobalt is by far the most used.

It is an ongoing strive to find alternative binders to cobalt due to its environmental and health impact. However, it is difficult to replace or limit the amount of cobalt without impacting material properties in a negative way. For cutting tools the substrate properties are important for the overall performance of the tool and even small changes in composition can have a detrimental impact on performance.

For cemented carbides with a Co binder there is a relationship between toughness and hardness that is difficult to change. For example, it is not possible to increase the toughness without having a decrease in hardness or vice versa.

Iron is a known binder element but is usually not preferred since it is considered to have a negative impact on the toughness of cemented carbides. Pure iron binders have a tendency to form brittle phases (i.e. martensite, Fe-carbides etc.). Additionally, the control of the carbon to produce a defect-free microstructure (precipitation of (W,Me)C subcarbides or graphite) is difficult to achieve in standard production.

It is an object of the invention to be able to manufacture a cemented carbide with an alternative binder phase which has equal or improved properties as compared to a cemented carbide with a Co binder.

It is another object of the invention to obtain a cemented carbide for which the hardness can be varied while the toughness is substantially maintained.

It is another object of the invention to obtain a cemented carbide which have a minimal grain growth of the WC grains during sintering.

### DETAILED DESCRIPTION OF THE INVENTION

The present invention relates to a cutting tool comprising a cemented carbide substrate where the cemented carbide comprises a hard phase comprising WC, a mixed carbide phase and metal binder, where the cemented carbide comprises the elements V, Cr, Ni and Fe in such amounts so that:
the weight fraction V/(V+Cr+Ni+Fe) is between 0.0030 and 0.050,
the weight fraction Cr/(V+Cr+Ni+Fe) is between 0.010 and 0.040
the weight fraction Ni/(V+Cr+Ni+Fe) is between 0.020 and less than 0.050
the weight fraction Fe/(V+Cr+Ni+Fe) is between 0.86 and 0.967.

The cemented carbide according to the present invention have the advantage that the hardness can be varied while the toughness is basically maintained.

Another advantage is that the WC grain size can be controlled since the grain growth during sintering is minimal partly due to the strong grain growth inhibitor effect of vanadium.

The cemented carbide according to the present invention comprises WC, a mixed carbide phase and a metal binder where the mixed carbide phase will be formed during sintering. Depending on the amount of, and which elements that are present in the cemented carbide, the exact composition of the mixed carbide phase is not completely known but can be described as a carbide phase with a particular stoichiometry which differs from the conventional gamma phase. When analyzed, the mixed carbide phase has a crystal structure similar to eta phase, however, eta phase usually contains large amounts of the binder metal. The mixed carbide phase contains small amounts of Fe, see EDX analysis in the examples. More specifically the phases can be one or more of these elements with atomic ratio V:W from 3:1 to 3:2, in the (V,W)ₓC_{y} phase.

Most of the V that is added will be found in the mixed carbide phase in the final cemented carbide together with small amounts of the added Cr and W from the WC. The metal binder can also comprise smaller amounts of other elements present in the cemented carbide that will inevitably dissolve in the metal binder during sintering.

In one embodiment of the present invention, the total amount of the elements Fe, Cr and Ni in the metal binder is at least 90 wt % of the binder, preferably at least 95 wt % of the binder. The binder can also comprise other elements, e.g. W present in the cemented carbide which is dissolved in the binder during sintering.

The amount of metal binder in the cemented carbide is preferably between 3 and 20 wt % of the cemented carbide, more preferably between 5 and 15 wt %. One way to determine the amount of metal binder is by image analysis or by chemical analysis of the cemented carbide composition.

The cemented carbide comprises V in such amount that the weight fraction V/(V+Cr+Ni+Fe) is between 0.0030 and 0.050, preferably between 0.010 and 0.030 and more preferably between 0.015 and 0.020. If the V content is too low, the WC grain growth during sintering will increase and if the V content is too high, the cemented carbide will rapidly decrease in toughness, causing embrittlement at WC interfaces.

The cemented carbide comprises Cr in such amount that the weight fraction Cr/(V+Cr+Ni+Fe) is between 0.010 and 0.040, preferably between 0.010 and 0.020. If the Cr content is too low, the solid solution strengthening effect of Cr in Fe will decrease leading to low hardness-toughness combinations; and if the Cr content is too high, the cemented carbide will form Cr-carbide precipitation at grain boundaries, worsening the properties of the material.

The cemented carbide comprises Ni in such amount that the weight fraction Ni/(V+Cr+Ni+Fe) is between 0.020 and less than 0.050, preferably between 0.020 and 0.045, more preferably between 0.020 and 0.030. If the Ni content is too low, the binder of the cemented carbide will present less ductility, leading to fragilization of the composite and if the Ni content is too high, the cemented carbide will decrease its strength and temperature stability to heat exposure.

The cemented carbide comprises Fe in such amount that the weight fraction Fe/(V+Cr+Ni+Fe) is between 0.860 and 0.967, preferably between 0.910 and 0.960.

In one embodiment of the present invention, the cemented carbide comprises no other components other than W, C, Fe, Ni, Cr and V, except for unavoidable impurities. By that is meant that no other elements are added as raw materials.

The cemented carbide may be essentially free from Co and by that is herein meant that no Co is added as raw material and that Co is present in the cemented carbide on a level of impurity, preferably below 1 wt %, more preferably below 0.5 wt %. Small amounts of Co are usually detected since some manufacturing equipment, like e.g. milling bodies, contains Co containing cemented carbide and can give a small contribution to the overall composition.

The hard phase comprises at least 50 wt % WC. The average grain size of the WC is suitably between 0.2 and 10 μm, preferably between 0.2 and 5 μm. The average grain size of the WC can e.g. be measured by using a mean linear intercept method on a SEM/LOM image.

In one embodiment of the present invention, the cemented carbide can also contain other constituents common in the art of cemented carbides, e.g. carbides, carbonitrides or nitrides of one or more of Ti, Ta and Nb. Elements from those carbides will then inevitably be dissolved in the binder during sintering.

In one embodiment of the present invention, the cemented carbide substrate is provided with a wear resistant CVD (Chemical vapor deposition) or PVD (Physical vapor deposition) coating.

In one embodiment of the present invention, the cemented carbide substrate is provided with a wear resistant PVD coating, suitably being a nitride, oxide, carbide or mixtures thereof of one or more of the elements selected from groups 4, 5 and 6 in the periodic table and optionally with Al and/or Si.

In yet another embodiment of the present invention, the cemented carbide substrate is provided with a wear resistant CVD coating.

In yet another embodiment of the present invention, the cemented carbide substrate is provided with a wear resistant CVD coating comprising several layers, suitably at least a carbonitride layer and an Al₂O₃ layer.

By cutting tool is herein meant a cutting tool insert, end mill or drill.

The present invention also relates to a method of making a cutting tool according to the above comprising a cemented carbide substrate as described above. The method comprises the following steps:
providing a WC powder,
providing powder(s) comprising the elements V, Fe, Ni and Cr
providing a milling liquid,
milling, drying, pressing and sintering the powders into a cemented carbide.

The raw materials comprising the elements V, Fe, Ni and Cr can be added as pure metals, alloys of two or more metals or as carbides, nitrides or carbonitrides thereof. The raw materials should be added in such amounts so that the binder phase, after sintering will have the composition as has been described above.

In one embodiment of the present invention, the powders are VC, Cr₃C₂, Fe and Ni.

The WC powder used with an average grain size of preferably 0.2-10 μm, more preferably 0.2-5 μm (FSSS).

Any liquid commonly used as a milling liquid in conventional cemented carbide manufacturing can be used. The milling liquid is preferably water, alcohol or an organic solvent, more preferably water or a water and alcohol mixture and most preferably a water and ethanol mixture. The properties of the slurry are dependent on the amount of milling liquid added. Since the drying of the slurry requires energy, the amount of liquid should be minimized to keep costs down. However, enough liquid needs to be added to achieve a pumpable slurry and avoid clogging of the system. Also, other compounds commonly known in the art can be added to the slurry e.g. dispersion agents, pH-adjusters etc.

An organic binder is also optionally added to the slurry in order to facilitate the granulation during the following spray drying operation but also to function as a pressing agent for any following pressing and sintering operations. The organic binder can be any binder commonly used in the art. The organic binder can e.g. be paraffin, polyethylene glycol (PEG), long chain fatty acids etc. The amount of organic binder is suitably between 15 and 25 vol % based on the total dry powder volume, the amount of organic binder is not included in the total dry powder volume.

The slurry comprising powders forming hard constituents and powders forming the binder phase, and possibly an organic binder is suitably mixed by a milling operation, either in a ball mill or attritor mill. The milling is suitably made by first forming a slurry comprising metal binder powder, the first and second powder fraction, and possibly an organic binder. Then the slurry is suitably milled in a ball mill or attritor mill to obtain a homogenous slurry blend.

The slurry containing the powdered materials mixed with the organic liquid and possibly the organic binder is atomized through an appropriate nozzle in the drying tower where the small drops are instantaneously dried by a stream of hot gas, for instance in a stream of nitrogen, to form agglomerated granules. For small scale experiments, also other drying methods can be used, e.g. pan drying.

Green bodies are subsequently formed from the dried powders/granules by a pressing operation such as uniaxial pressing, multiaxial pressing etc.

The green bodies formed from the powders/granules made according to the present invention, is subsequently sintered according to any conventional sintering methods e.g. vacuum sintering, Sinter HIP, spark plasma sintering, gas pressure sintering (GPS) etc.

In one embodiment of the present invention, the sintering temperature is between 1350 and 1550 °C.

In one embodiment of the present invention, the sintering process is sinter HIP performed at a temperature of between 1350 and 1550 °C, and a pressure of at least 40 Bar, preferably between 40 and 80 Bar.

In one embodiment of the present invention the cemented carbide substrates are provided with a coating.

In one embodiment of the present invention the cemented carbide substrates made according to the above, are provided with a wear resistant coating using CVD or PVD-technique.

In one embodiment of the present invention, the cemented carbide substrate is provided with a wear resistant PVD coating, suitably being a nitride, oxide, carbide or mixtures thereof of one or more of the elements selected from groups 4, 5 and 6 in the periodic table and optionally with Al and/or Si.

In one embodiment of the present invention a CVD coating is deposited comprising a first TiCN layer deposited by MTCVD and a second α-Al₂O₃ layer deposited by CVD. Possibly an outermost color layer for wear detection, e.g. a TiN layer, can also be deposited.

The coating can also be subjected to additional treatments, such as brushing, blasting etc.

The present invention also discloses a cemented carbide cutting tool made according to the method described above.

### DRAWINGS

FIG. 1 describes a graph comparing the cemented carbides according to the present invention, filled circles, with cemented carbides with Co binder, unfilled circles, collected from literature data, with regard to hardness and toughness (K1C) values.

FIG. 2 shows a close up of the area within the dotted line in FIG. 1.

FIG. 3 shows the relation between K1c difference (ΔK1c) and V addition to binder for 3 different sintering temperatures from Example 2 (numbers indicate sample numbers from Table 2).

FIG. 4 shows the XRD diffractogram of cemented carbide having different V contents where the peaks of the mixed carbide phase marked A is clearly visible. The peak marked with B is the peak for WC.

FIG. 5 shows an SEM-EDX image of the microstructure of a cemented carbide according to the present invention showing the layered structure of all elements where the mixed carbide (1), WC grains (2) and binder phase (3) is shown.

FIG. 6 shows an SEM-EDX image of the same part of the microstructure as in FIG. 6 where tungsten has been highlighted and 1 is the mixed carbide, 2 is the WC grains and 3 is the binder phase.

FIG. 7 shows an SEM-EDX image of the same part of the microstructure as in FIG. 6 where Iron has been highlighted and 2 is the WC grains and 3 is the binder phase.

FIG. 8 shows an SEM-EDX image of the same part of the microstructure as in FIG. 6 where Vanadium has been highlighted and 1 is the mixed carbide phase.

### EXAMPLE 1

Cemented carbides were prepared from raw materials being Cr₃C₂, VC, Ni and Fe in amounts so that the composition of the total powder, excluding the WC, was 91 wt % Fe, 3.5 wt % Ni, 1.4 wt % Cr and 4.0 wt % V. Carbon black was added up to 0.4% of mixture weight, more specifically between 0.15 and 0.4%. The WC powder had an average particle size of 0.83 μm (FSSS). The amount of V+Cr+Ni+Fe in the cemented carbide was varied in accordance with Table 1. The raw material powders were milled in a ball mill for 8 h together with an organic binder (2 wt % PEG based on total powder weight) and a milling liquid (water/ethanol) to form a slurry which was dried and milled in agate mortar to obtain a powder blend. The powder was pressed into green bodies. The green bodies were sintered in a HIP (hot isostatic pressure) furnace where maximum sintering temperature was 1450 °C and sintering time was 1 h at 40 mbar vacuum sintering followed by 15 min 50 bar high-pressure step to reduce porosity of the samples.

The toughness (K1C) and the hardness (HV30) were measured on the sintered bodies after grinding and polishing. The HV30 has been measured according to ASTM B294. The fracture toughness, K1C, has been measured according to Shetty.

TABLE 1

| | V + Cr + Ni + Fe | Sintering | | |
|---|---|---|---|---|
| | (wt % of total | temperature | K1C | |
| | cemented carbide) | (°C) | (MPa/m) | HV30 |
| Invention 1 | 10.4 | 1410 | 8.26 | 1850 |
| Invention 2 | 9.0 | 1450 | 8.09 | 1909 |
| Invention 3 | 7.8 | 1450 | 8.24 | 2007 |
| Invention 4 | 6.5 | 1450 | 7.86 | 2115 |
| Invention 5 | 10.3 | 1410 | 8.06 | 1828 |
| Invention 6 | 12.4 | 1410 | 8.04 | 1724 |
| Invention 7 | 14.5 | 1410 | 7.82 | 1636 |
| Invention 8 | 16.5 | 1410 | 7.87 | 1527 |

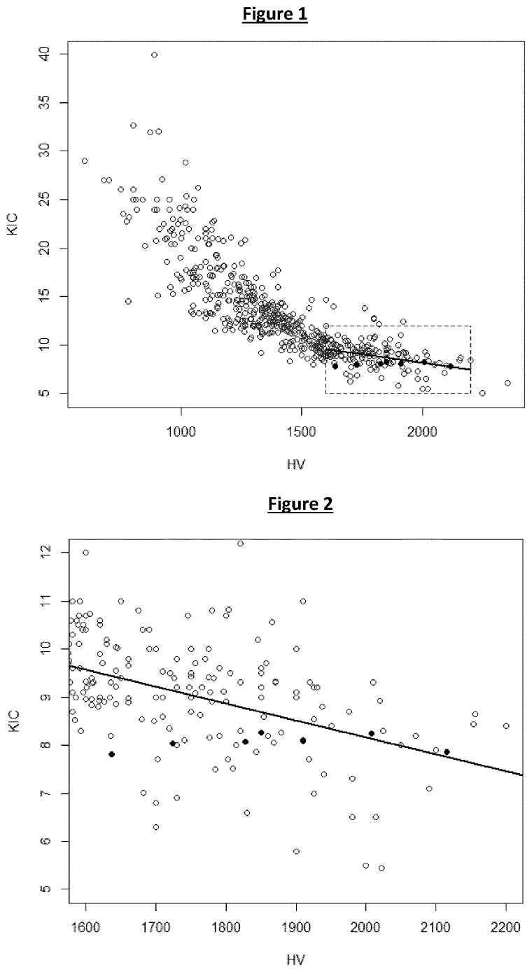

To compare the results in Table 1 with cemented carbide having a Co binder, the hardness and toughness (K1C) values from Table 1 are plotted together with values for cemented carbides having pure Co metal as binder based on literature data, see FIGS. 1 and 2. The data from Table 1 has been fitted to a linear model fitted on the data in the range HV30—between 1600 and 2200 and K1C—between 5 and 12. The range and model are displayed on the graph as dashed frame and solid line. Results obtained in the present invention for variable binder content are displayed as solid circles on the same range.

As can be seen in FIGS. 1 and 2, the cemented carbides according to the present invention have hardness and toughness properties in the same range as cemented carbides having a Co binder.

### EXAMPLE 2

Powders with variation in V content was prepared in the same manner from the same raw material as in Example 1 with the compositions according to Table 2. The samples were sintered in a HIP furnace at 3 different temperatures (1410, 1450 and 1500 °C), see Table 2. Sintering time is 60 min at highest temperature vacuum sintering 40 mbar followed by 15 min high pressure sintering with 50 bar.

The samples were analyzed with regard to K1C and hardness in the same manner as in Example 1. In order to evaluate the effect of the different V contents, the difference between measured and calculated K1c (ΔK1c) is evaluated against V addition to binder phase, see Table 2. The value ΔK1c is the difference between measured K1c and K1c value calculated from linear model fitted on selected subset of literature data for WC—Co cemented carbides (displayed in FIG. 1):

K1c_calculated=15.22−0.003527*HV.

TABLE 2

| | | V/(V + | Cr/(V + | Ni/(V + | Fe/(V + | |
|---|---|---|---|---|---|---|
| | Sintering | Cr + | Cr + | Cr + | Cr + | |
| Sample | temperature | Ni + | Ni + | Ni + | Ni + | |
| No. | (°C) | Fe) | Fe) | Fe) | Fe) | ΔK1c |
| 1 | 1410 | 0.000 | 0.015 | 0.035 | 0.950 | −1.23 |
| 2 | 1450 | 0.000 | 0.015 | 0.035 | 0.950 | −0.88 |
| 3 | 1500 | 0.000 | 0.015 | 0.035 | 0.950 | −0.99 |
| 4 | 1410 | 0.020 | 0.015 | 0.035 | 0.930 | −1.09 |
| 5 | 1450 | 0.020 | 0.015 | 0.035 | 0.930 | −0.84 |
| 6 | 1500 | 0.020 | 0.015 | 0.035 | 0.930 | −0.80 |
| 7 | 1410 | 0.040 | 0.015 | 0.034 | 0.912 | −1.31 |
| 8 | 1450 | 0.040 | 0.015 | 0.034 | 0.912 | −1.03 |
| 9 | 1500 | 0.040 | 0.015 | 0.034 | 0.912 | −1.06 |
| 10 | 1410 | 0.059 | 0.014 | 0.033 | 0.894 | −1.49 |
| 11 | 1450 | 0.059 | 0.014 | 0.033 | 0.894 | −1.02 |
| 12 | 1500 | 0.059 | 0.014 | 0.033 | 0.894 | −1.21 |
| 13 | 1410 | 0.077 | 0.014 | 0.033 | 0.877 | −1.96 |
| 14 | 1500 | 0.077 | 0.014 | 0.033 | 0.877 | −2.10 |

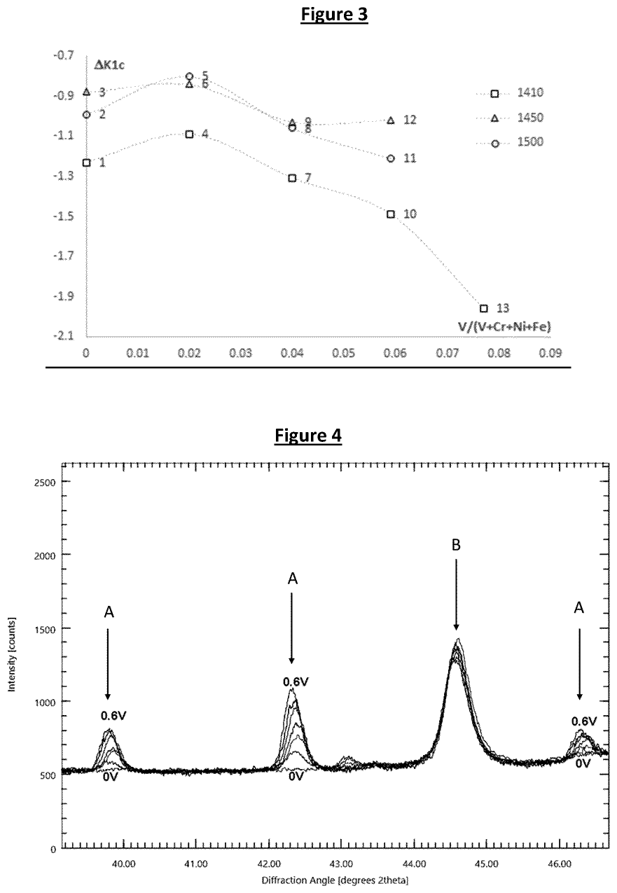

In FIG. 3 the V content is plotted against ΔK1c for the three sintering temperatures and it can clearly be seen that the best properties are obtained at a V content according to the present invention (numbers indicate sample numbers from Table 2).

### EXAMPLE 3

The samples from Example 2 were analyzed using XRD. The samples were prepared by casting in bakelite, grinding and polishing. XRD measurements were performed on a Bruker Discover D8 diffractometer with Davinci design equipped with a 1 μS Microfocus Source (CuK_{α} radiation, λ=1.5418 Å), a Våntec-500 area detector and an ¼ Eulerian cradle. The X-ray source was operated at 50 kV and 1 mA. The sample was mounted with adhesive tape to the sample holder. A collimator size of 1.0 mm diameter was used in all experiments. Measurements were conducted at a polished side of the investigated insert. Data were collected in the 2θ range 10°-140°.

The XRD data were analyzed with software DIFFRAC EVA (Bruker) and High Score Plus (Malvern Panalytical).

In FIG. 4, a XRD diffractogram is shown where the peak for the WC is marked and also 3 peaks for the mixed carbide phase are shown. The XRD diffractogram of samples with different V content clearly shows that the peaks indicating the mixed carbide are increasing with increased V content.

### EXAMPLE 4

3 samples according to the invention were analyzed by SEM-EDX (Energy-dispersive X-ray spectroscopy) using a Zeiss Supra 40 electronic microscope with AZtec software from Oxford Instruments to perform element mapping and composition analysis at selected points of the mixed carbide phase. Acceleration voltage was 10 kV and working distance 8.5 mm. Specifically, the mixed carbide phase was investigated.

The samples were Invention 5 (from Table 1) and two additional samples according to the invention, Invention 9 and Invention 10. Invention 9 and Invention 10 were made in the same manner as in Example 1 and where Invention 9 and Invention 10 contained 7.7 wt % and 16.5 wt % of the same Fe—V—Ni—Cr mixture as in Example 1, respectively. The same WC raw material as in Example 1 was used for Invention 9, whereas a WC raw material having a particle size of 7.15 μm (FSSS) was used.

Specifically, the mixed carbide phase was investigated.

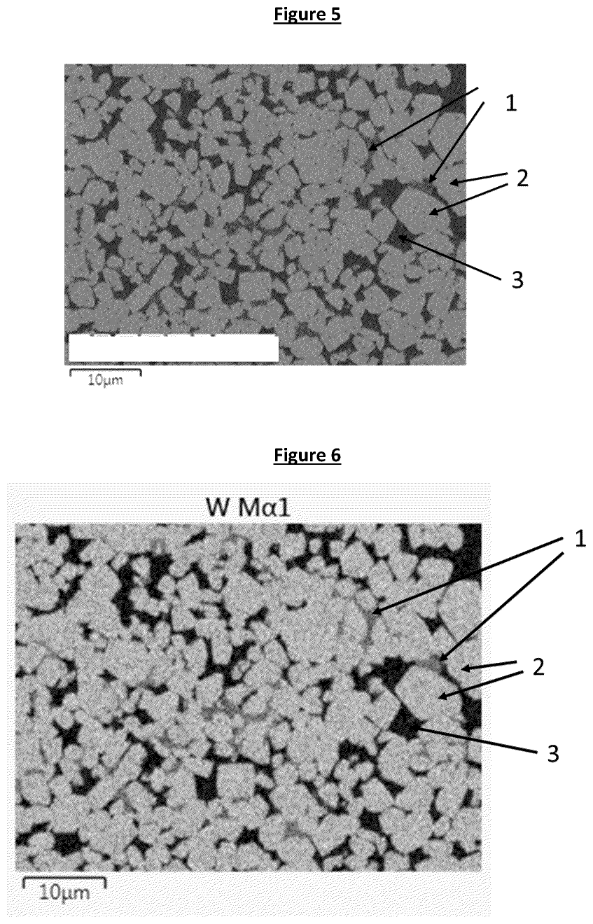

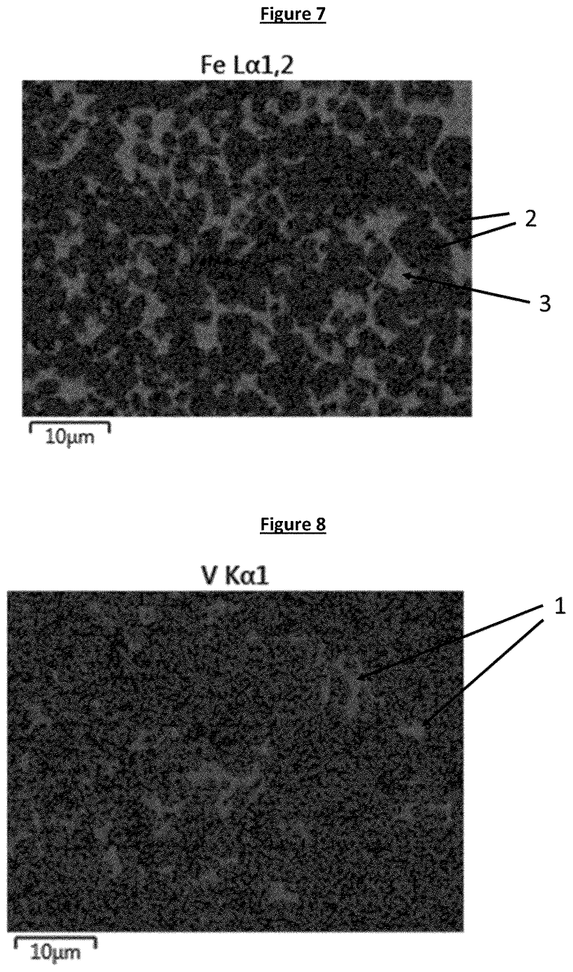

In FIGS. 5-8 the EDX images of Invention 10 are shown where V, Fe and W are highlighted and it can be seen that the mixed carbide phase contains high amounts of V and W but small amounts of Fe (not visible in the image). It can also be seen that the binder contains high amounts of Fe but almost no V.

Analyzing the average composition of the mixed carbide phase gave the composition in wt % as shown in Table 3:

TABLE 3

| | C | V | Cr | Fe | Ni | W | V:W |
|---|---|---|---|---|---|---|---|
| | (wt | (wt | (wt | (wt | (wt | (wt | atomic |
| Sample No | %) | %) | %) | %) | %) | %) | ratio |
| Invention 5 | 15.7 | 32.3 | 1.16 | 0.96 | 0.22 | 49.6 | 7:3 |
| Invention 5 | 16.6 | 25.6 | 0.68 | 0.84 | 0 | 56.3 | 3:2 |
| Invention 9 | 15.5 | 24 | 0.88 | 0.95 | 0.43 | 58.2 | 3:2 |
| Invention 10 | 16.8 | 39.2 | 1.07 | 1.03 | 0.35 | 41.6 | 3:1 |
| Invention 10 | 17.7 | 37.5 | 0.98 | 0.66 | 0 | 43.2 | 3:1 |
| Invention 10 | 15.8 | 37.9 | 0.99 | 0.91 | 0 | 44.5 | 3:1 |

As can be seen in Table 3, the mixed carbide phase contains mainly W; C and V but only small amounts of Fe, NI and Cr.

1. A cutting tool comprising a cemented carbide substrate where the cemented carbide comprises a hard phase comprising WC, a mixed carbide phase and a metal binder, where the cemented carbide comprises elements V, Cr, Ni and Fe in such amounts so that:
a weight fraction V/(V+Cr+Ni+Fe) is between 0.0030 and 0.050,
a weight fraction Cr/(V+Cr+Ni+Fe) is between 0.010 and 0.040,
a weight fraction Ni/(V+Cr+Ni+Fe) is between 0.030 and less than 0.050, and
a weight fraction Fe/(V+Cr+Ni+Fe) is between 0.86 and 0.967.

2. The cutting tool according to claim 1, wherein an amount of metal binder content in the cemented carbide is between 3 to 20 wt %.

3. The cutting tool according to claim 1, wherein the total amount of the elements Fe, Cr and Ni in the metal binder is at least 90 wt % of the binder.

4. The cutting tool according to claim 1, wherein the weight fraction V/(V+Cr+Ni+Fe) is between 0.010 and 0.040.

5. The cutting tool according to claim 1, wherein the weight fraction Cr/(V+Cr+Ni+Fe) is between 0.012 and 0.030.

6. The cutting tool according to claim 1, wherein the weight fraction Ni/(V+Cr+Ni+Fe) is between 0.02 and 0.045.

7. The cutting tool according to claim 1, further comprising a coating disposed on the substrate.

8. A method of making a cutting tool comprising a cemented carbide substrate according to claim 1, wherein the method comprises the following steps:
providing a WC powder;
providing powder(s) comprising the elements V, Fe, Ni and Cr;
providing a milling liquid; and
milling, drying, pressing and sintering the WC, V, Fe, Ni and Cr powders into a cemented carbide.

9. The method of making a cutting tool according to claim 8, wherein the sintering is performed at a sintering temperature of between 1350 and 1550 °C and at a pressure of at least 40 Bar.
